(19) United States
(12) Patent Application Publication
(10) Pub. No.: US 2013/0330571 A1
(43) Pub. Date: Dec. 12, 2013

(54) METHOD AND APPARATUS FOR PROVIDING IMPROVED BACKSIDE METAL CONTACTS TO SILICON CARBIDE

(71) Applicants: Ramesh Varma, Ellicott City, MD (US); Thomas J. Knight, Silver Spring, MD (US)

(72) Inventors: Ramesh Varma, Ellicott City, MD (US); Thomas J. Knight, Silver Spring, MD (US)

(73) Assignee: NORTHROP GRUMMAN SYSTEMS CORPORATION, Falls Church, VA (US)

(21) Appl. No.: 13/489,904

(22) Filed: Jun. 6, 2012

(51) Int. Cl. B23K 31/02; B32B 7/10; B23K 1/20

(52) U.S. Cl. 428/627; 228/172

(57) ABSTRACT

Embodiments of a method and apparatus are disclosed for providing improved backside metal contacts to silicon carbide. Embodiments include depositing a barrier layer on the bottom surface of a silicon carbide wafer. The barrier layer is located between the silicon carbide wafer and a silicon layer. The silicon carbide wafer is separated into individual silicon carbide die. Embodiments further include mechanically scrubbing each silicon carbide die on the top surface of a package, forming a gold-silicon eutectic solder that bonds the silicon carbide die to the package. The barrier layer reduces or eliminates diffusion of species into the gold-silicon eutectic solder to reduce or eliminate voids in the gold-silicon eutectic solder.

### BACKGROUND

The prior art design for providing backside contacts to semi-conductor devices uses nickel (Ni) or nickel-cobalt (Ni—Co) as a contact layer to adhere a silicon carbide (SiC) die (which is cut into individual die from a SiC wafer) to the package. FIGS. 1 and 2 illustrate the prior art design. Referring to FIG. 1, metal layers, such as a titanium (Ti) layer 104, a Ni—Co layer 106, and a silicon (Si) layer 108, are deposited onto a SiC wafer 102. The Ti layer 104 serves as an adhesion layer, the Ni—Co layer 106 serves as a contact layer, and the Si layer 108 serves as an eutectic solder formation layer. The SiC wafer 102 may be, for example, three inches or more in diameter. The SiC wafer 102 is cut (or diced) and separated into individual die and each SiC die 120 is then mechanically scrubbed on top of a ceramic package 112 at about 400° C. The ceramic package 112 includes a ceramic substrate 116, has a copper-tungsten flange or heat sink 114 at the bottom, and has a gold layer 110 on the top surface to serve as an eutectic solder formation layer. As a result of the thermo-mechanical energy from the scrubbing, Si in the Si layer 108 and Au in the Au layer 110 reacts, forming a gold-silicon (Au—Si) eutectic solder 210, which is a binary compound (shown in FIG. 2). As shown in FIG. 2, the Au—Si eutectic solder 210 bonds the SiC die 120 to the ceramic package 112.

The problem with the prior art design is the incorporation of Ni into the Au—Si eutectic solder 210, which affects the homogeneity of the Au—Si eutectic solder 210, impedes the Au—Si eutectic formation, and impacts the solder flow and wetting on the ceramic package 112. The Ni incorporation creates new intermetallic or ternary compounds, which has higher melting points compared to Au—Si. As a result, the Ni incorporation increases the melting point of Au—Si, which causes the Au—Si eutectic solder 210 to freeze before the completion of the bonding of the SiC die 120 to the ceramic package 112. Such solder freezing causes localized or patchy joints between the SiC die 120 and the ceramic package 112, which is one of the root causes of solder voids 220 (shown in FIG. 2). Solder voids 220 impede heat transfer and create hot spots. Such hot spots degrade the performance and reliability of, for example, SiC static induction transistor (SIT) devices, particularly in high power and temperature applications.

### SUMMARY

An embodiment of a method is disclosed for providing improved backside metal contacts to silicon carbide. The method includes depositing a barrier layer on a bottom surface of a silicon carbide wafer. The barrier layer is located between the silicon carbide wafer and a silicon layer. The silicon carbide wafer is separated into individual silicon carbide dies. The method further includes mechanically scrubbing each silicon carbide die on the top surface of a package to form a gold-silicon eutectic solder that bonds the silicon carbide dies to the package. The barrier layer reduces or eliminates diffusion of species into the gold-silicon eutectic solder to reduce or eliminate voids in the gold-silicon eutectic solder.

Another embodiment of a method is disclosed for providing improved backside metal contacts to silicon carbide. The method includes depositing a contact layer on the bottom surface of a silicon carbide wafer. The contact layer includes a top surface and a bottom surface, and the top surface of the contact layer is attached to the bottom surface of the silicon carbide wafer. The method further includes depositing a barrier layer on the bottom surface of the contact layer. The barrier layer includes a top surface and a bottom surface. The method further includes depositing a silicon layer on the bottom surface of the barrier layer, separating the silicon carbide wafer into individual silicon carbide dies, mechanically scrubbing each silicon carbide die on the top surface of a package to form a gold-silicon eutectic solder that bonds the silicon carbide dies to the package. The barrier layer reduces or eliminates diffusion of species into the gold-silicon eutectic solder to reduce or eliminate voids in the gold-silicon eutectic solder.

An embodiment of an apparatus is disclosed for providing improved backside metal contacts to silicon carbide. The apparatus includes a silicon carbide wafer that includes a top surface and a bottom surface, and a contact layer deposited on the bottom surface of the silicon carbide wafer. The contact layer includes a top surface and a bottom surface, and the top surface of the contact layer is attached to the bottom surface of the silicon carbide wafer. The apparatus further includes a barrier layer deposited on the bottom surface of the contact layer. The barrier layer includes a top surface and a bottom surface. The apparatus further includes a silicon layer deposited on the bottom surface of the barrier layer. The silicon carbide wafer is separated into individual silicon carbide dies. A gold-silicon eutectic solder is formed by mechanically scrubbing each silicon carbide die on a top surface of a package. The gold-silicon eutectic solder bonds the silicon carbide dies to the package. The barrier layer reduces or eliminates diffusion of species, into the gold-silicon eutectic solder to reduce or eliminate voids in the gold-silicon eutectic solder.

### DESCRIPTION OF THE DRAWINGS

The detailed description will refer to the following drawings, wherein like numerals refer to like elements, and wherein:

FIGS. 1 and 2 illustrate the current design of forming a gold-silicon eutectic solder;

FIGS. 3 and 4 illustrate an embodiment of a method and apparatus for providing improved backside metal contacts to silicon carbide;

FIG. 5 illustrates an exemplary comparison of die shear force in kilogram (Kg) between the current design and an embodiment of a method and apparatus for providing improved backside metal contacts to silicon carbide;

FIG. 6 illustrates an exemplary comparison of average device operating temperature of a 45 cell package between the current design and an embodiment of a method and apparatus for providing improved backside metal contacts to silicon carbide; and

FIG. 7 is a flow chart illustrating an embodiment of a method for providing improved backside metal contacts to silicon carbide.

### DETAILED DESCRIPTION

As noted above, the design used currently for providing backside metal contacts uses titanium (Ti) and nickel (Ni) or titanium (Ti) and nickel-cobalt (Ni—Co) as a contact layer to adhere a silicon carbide (SiC) die (which is cut into individual dies from a SiC wafer) to a package. Specifically, the contact layer is located between a silicon (Si) layer and the SiC wafer, which is cut (or diced) and separated into individual dies. Each SiC die is mechanically scrubbed on top of the heated package, which includes a copper-tungsten flange or heat sink at the bottom and a gold (Au) layer on the top surface. Si in the Si layer and Au in the Au layer reacts as a result of the thermo-mechanical energy from the scrubbing and heat on the package, forming a gold-silicon (Au—Si) eutectic solder. The Au—Si eutectic solder bonds the SiC die to the package.

However, as also noted above, the current design involves diffusion or incorporation of Ni or Ni—Co into a gold-silicon (Au—Si) eutectic solder, which increases the melting point of the Au—Si eutectic solder, and causes the Au—Si eutectic solder to freeze before the completion of the bonding of the SiC die to the package. Such solder freezing causes localized or patchy joints between the SiC die and the package, which is one of the root causes of solder voids. Solder voids impede heat transfer and create hot spots. Such hot spots degrade the performance and reliability of, for example, SiC static induction transistor (SIT) devices, particularly in high power and temperature applications.

Embodiments of a method and apparatus are disclosed for providing improved backside metal contacts to silicon carbide. One skilled in the art will appreciate that backside can also be referred to as bottom-side, bottom surface, and the like. Embodiments provide a barrier layer between the SiC wafer and the Si layer to reduce or eliminate the incorporation of species, such as Ni or Ni—Co, in the Au—Si eutectic solder. The material used for the barrier layer may be, for example, titanium-platinum (Ti—Pt) or titanium-tungsten (Ti—W). Embodiments may reduce or eliminate undesirable Ni to Au—Si solder joint voids, thus improving the performance of SiC SIT devices.

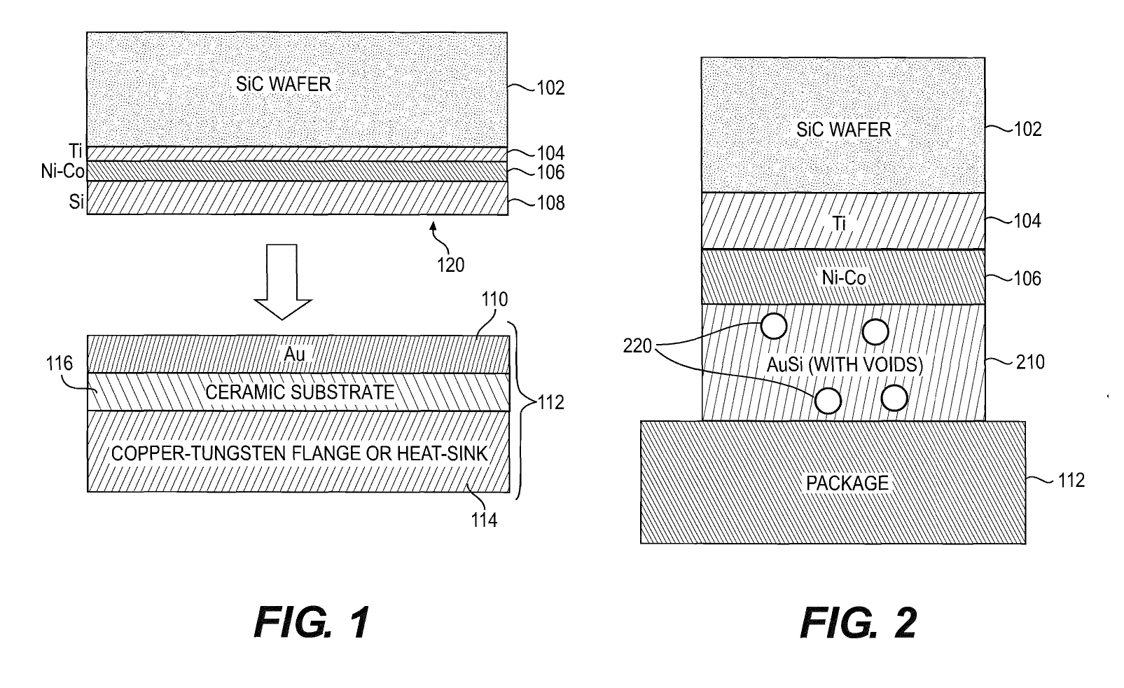

As shown in FIGS. 1 and 2, the contact layer in the current design is the Ni—Co layer 106. While cobalt (Co) minimizes the incorporation of Ni into the Au—Si eutectic solder 210, voids 220 may be formed in the Au—Si eutectic solder 210. Embodiments of the method and apparatus provide a barrier layer to reduce or eliminate the diffusion or incorporation of Ni or Ni—Co into the Au—Si eutectic solder and to reduce or eliminate the voids in the Au—Si eutectic solder.

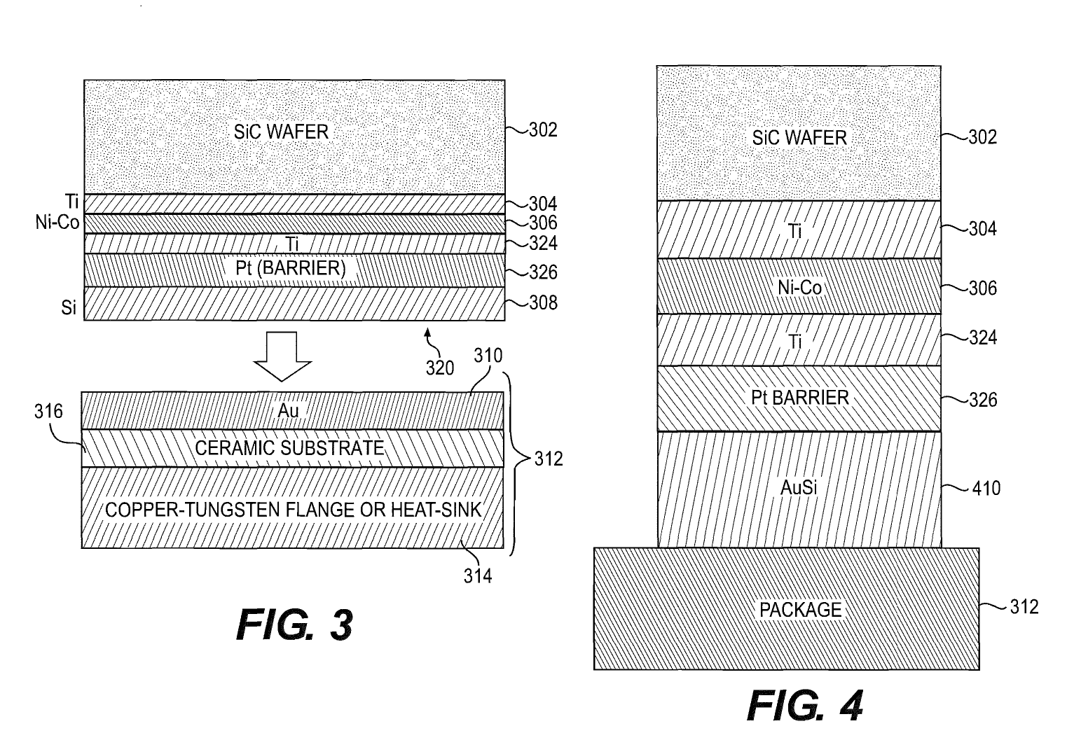

FIGS. 3 and 4 illustrate an embodiment of the method and apparatus for providing improved backside metal contacts to silicon carbide. Similar to FIGS. 1 and 2, metal layers, such as a titanium (Ti) layer 304, a Ni—Co layer 306 (or a Ni layer), and a silicon (Si) layer 308, are deposited onto a SiC wafer 302. The Ti layer 304 may serve as an adhesion layer, the Ni—Co layer 306 may serve as a contact layer, and the Si layer 308 serves as serve as an eutectic solder formation layer.

An embodiment provides a barrier layer 326 composed of barrier material, such as platinum (Pt) or tungsten (W), between the Ni—Co layer 306 and the Si layer 308 using adhesive material in an adhesion layer 324, such as a second Ti layer. The SiC wafer 302 may be, for example, three inches or more in diameter. The SiC wafer 302 is cut (or diced) and separated into individual dies and each SiC die 320 is than mechanically scrubbed on top of a ceramic package 312 at, for example, 400° C. The ceramic package 312 includes a ceramic substrate 316, has a copper-tungsten flange or heat sink 314 at the bottom, and has a gold layer 310 on the top surface to serve as an eutectic solder formation layer. As a result of the thermo-mechanical energy from the scrubbing, Si in the Si layer 308 and Au in the Au layer 310 reacts, forming a gold-silicon (Au—Si) eutectic solder 410, which is a binary compound (shown in FIG. 4). As shown in FIG. 4, the Au—Si eutectic solder 410 bonds the SiC die 320 to the ceramic package 312.

The barrier layer 326 may include barrier metals, such as Ti—Pt or Ti—W, and may improve the interface between the SiC die 320 and the ceramic package 312 by reducing the diffusion or incorporation of Ni or Ni—Co into the Au—Si eutectic solder 410, and thus reducing or eliminating voids formed in the Au—Si eutectic solder 410.

Specifically, metal Pt, for example, in the barrier layer 326 does not allow species, such as Ni or Ni—Co to diffuse through. Since Ni or Ni—Co does not diffuse into the Au—Si eutectic solder 410 during eutectic melting (e.g., reaction between Au and Si), the eutectic solder 410 remains pure or binary. One skilled in the art will appreciate that the barrier layer 326 may include barrier materials other than Ti—Pt or Ti—W to reduce the diffusion or incorporation of Ni or Ni—Co into the Au—Si eutectic solder 410.

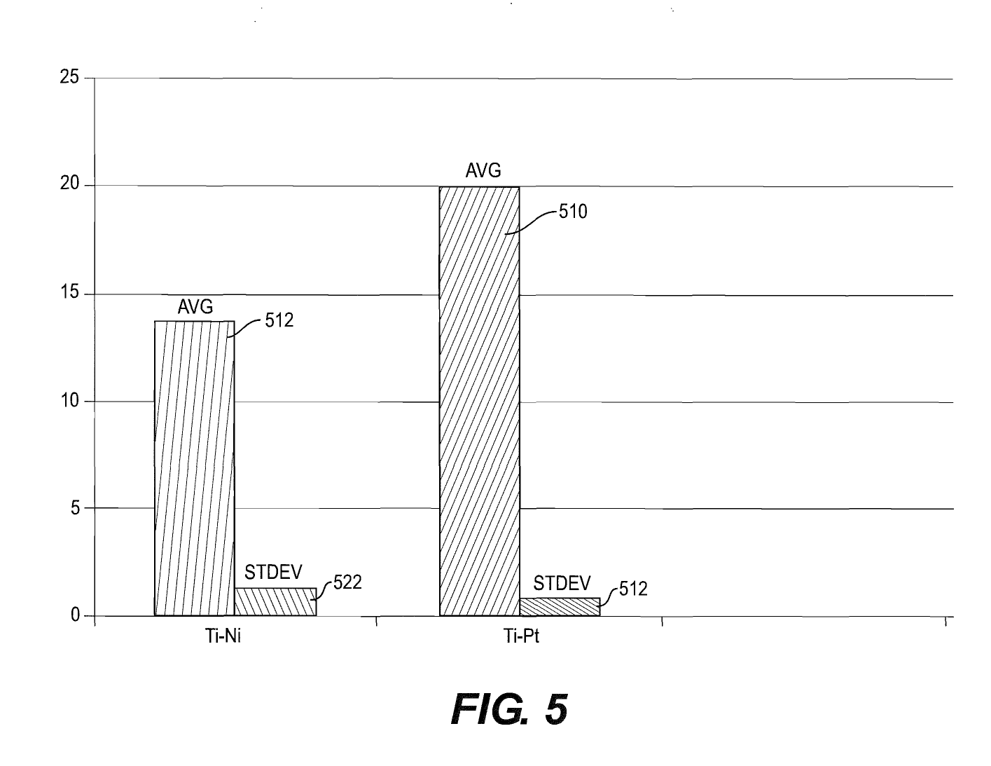

FIG. 5 illustrates an exemplary comparison of wafer shear force in kilogram (Kg) between the current design (e.g., using metals Ti—Ni) and an embodiment of a method and apparatus for providing improved backside metal contacts to silicon carbide (e.g., using metals Ti—Pt). As shown in FIG. 5, Ti—Pt has higher average force 510 than that of Ti—Ni 512, indicating more area of contact and less voids. The barrier layer 324, 326 may reduce the voids in the Au—Si eutectic solder 410 by approximately 33%. The standard deviation 512, 522 is the variation (+ or −) from the average. The standard deviation 512 for Ti—Pt and the standard deviation 522 for Ti—Ni are about the same.

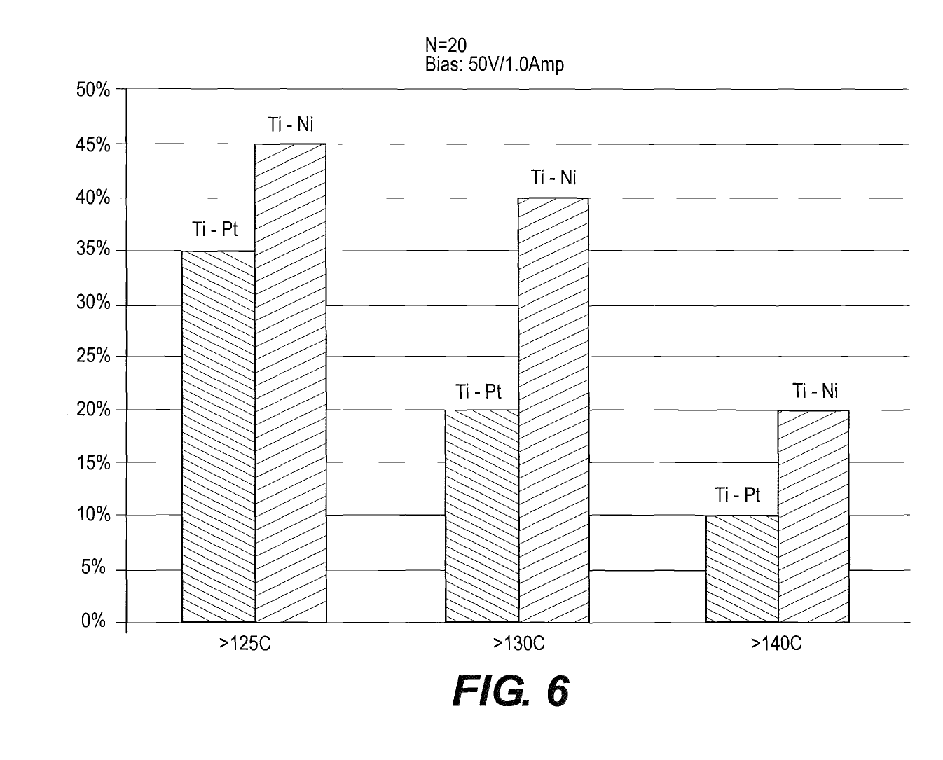

FIG. 6 illustrates an exemplary comparison of average device operating temperature between the current design (e.g., using metals Ti—Ni) and an embodiment of a method and apparatus for providing improved backside metal contacts to silicon carbide (e.g., using metals Ti—Pt). As shown in FIG. 6, Ti—Pt devices operate at lower temperature compared to Ti—Ni. Specifically, both average and maximum device temperatures are lower for the barrier layer contacts compared to the Ni and Ni—Co metals used in the current design.

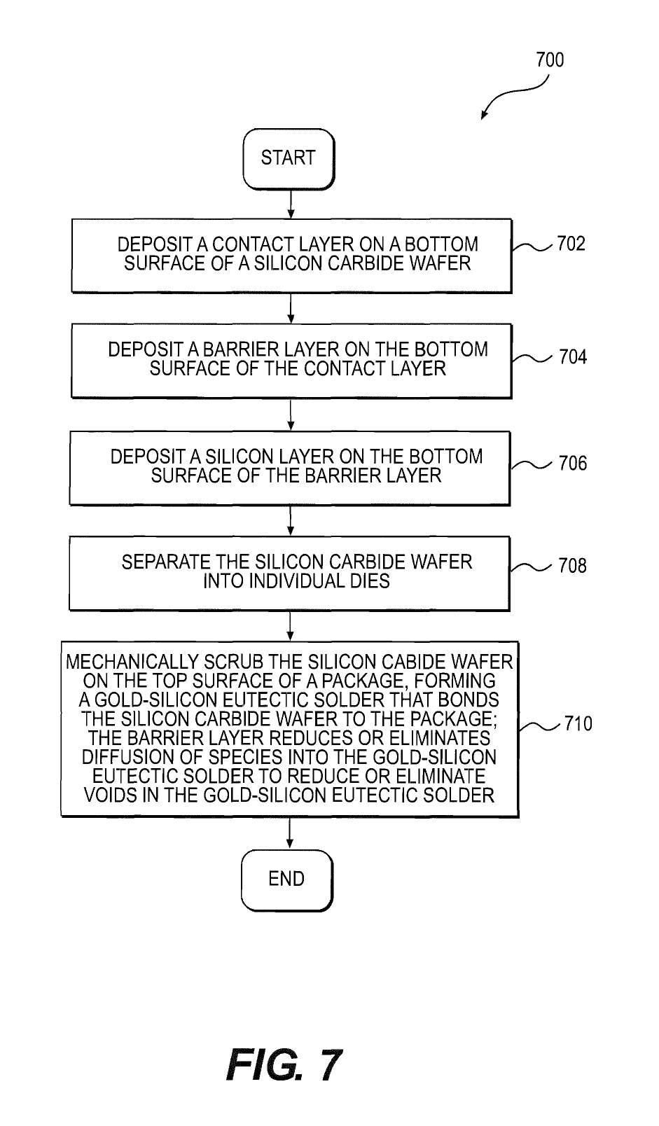

FIG. 7 is a flow chart illustrating an embodiment of a method 700 for providing improved backside metal contacts to silicon carbide. Method 700 includes depositing a contact layer on a bottom surface of a silicon carbide wafer (block 702). The contact layer includes a top surface and a bottom surface, and the top surface of the contact layer is attached to the bottom surface of the silicon carbide wafer. Method 700 further includes depositing a barrier layer on the bottom surface of the contact layer (block 704). The bather layer includes a top surface and a bottom surface. Method 700 further includes depositing a silicon layer on the bottom surface of the barrier layer (block 706), separating the silicon carbide wafer into a plurality of individual silicon carbide dies (block 708), and mechanically scrubbing each silicon carbide die on a top surface of a package, forming a gold-silicon eutectic solder that bonds the silicon carbide dies to the package (block 710). The barrier layer reduces or eliminates diffusion of species into the gold-silicon eutectic solder to reduce or eliminate voids in the gold-silicon eutectic solder.

The terms and descriptions used herein are set forth by way of illustration only and are not meant as limitations. Those skilled in the art will recognize that many variations are possible within the spirit and scope of the invention as defined in the following claims, and their equivalents, in which all terms are to be understood in their broadest possible sense unless otherwise indicated.

What is claimed is:

1. A method for providing improved backside metal contacts to silicon carbide, comprising:
depositing a barrier layer on a bottom surface of a silicon carbide wafer, wherein the barrier layer is located between the silicon carbide wafer and a silicon layer, and wherein the silicon carbide wafer is separated into individual silicon carbide dies; and
mechanically scrubbing each silicon carbide die on a top surface of a package to form a gold-silicon eutectic solder that bonds the silicon carbide dies to the package,
wherein the barrier layer reduces or eliminates diffusion of species into the gold-silicon eutectic solder to reduce or eliminate voids in the gold-silicon eutectic solder.

2. The method of claim 1, wherein the package includes a gold layer located on the top surface of the package, and wherein silicon in the silicon layer and gold in the gold layer reacts as a result of thermo-mechanical energy to form the gold-silicon eutectic solder.

3. The method of claim 1, further comprising depositing an adhesion layer, wherein the barrier layer is attached to the silicon carbide wafer using adhesive material in the adhesion layer, and wherein the barrier layer and the adhesion layer are composed of material including titanium-platinum (Ti—Pt).

4. The method of claim 1, further comprising depositing an adhesion layer, wherein the barrier layer is attached to the silicon carbide wafer using adhesive material in the adhesion layer, and wherein the barrier layer and the adhesion layer are composed of material including titanium-tungsten (Ti—W).

5. The method of claim 1, further comprising depositing a contact layer between the silicon carbide wafer and the barrier layer, and wherein the contact layer is composed of material including one or more of nickel (Ni) and nickel-cobalt (Ni—Co).

6. The method of claim 5, wherein the barrier layer reduces or eliminates diffusion of Ni or Ni—Co into the gold-silicon eutectic solder.

7. The method of claim 5, further comprising depositing an adhesion layer, wherein the contact layer is attached to the silicon carbide wafer using adhesive material in the adhesion layer.

8. The method of claim 1, wherein the package is a ceramic package.

9. The method of claim 1, further comprising depositing the silicon layer on a bottom surface of the barrier layer.

10. A method for providing improved backside metal contacts to silicon carbide, comprising:
depositing a contact layer on a bottom surface of a silicon carbide wafer, wherein the contact layer includes a top surface and a bottom surface, and wherein the top surface of the contact layer is attached to the bottom surface of the silicon carbide wafer;
depositing a barrier layer on the bottom surface of the contact layer, wherein the barrier layer includes a top surface and a bottom surface;
depositing a silicon layer on the bottom surface of the barrier layer, separating the silicon carbide wafer into individual silicon carbide dies; and
mechanically scrubbing each silicon carbide die on a top surface of a package to form a gold-silicon eutectic solder that bonds the silicon carbide dies to the package,
wherein the barrier layer reduces or eliminates diffusion of species into the gold-silicon eutectic solder to reduce or eliminate voids in the gold-silicon eutectic solder.

11. The method of claim 10, wherein the package includes a gold layer located on the top surface of the package, and wherein silicon in the silicon layer and gold in the gold layer reacts as a result of thermo-mechanical energy to form the gold-silicon eutectic solder.

12. The method of claim 10, further comprising depositing an adhesion layer, wherein the barrier layer is attached to the silicon carbide wafer using adhesive material in the adhesion layer, and wherein the barrier layer and the adhesion layer are composed of material including titanium-platinum (Ti—Pt).

13. The method of claim 10, further comprising depositing an adhesion layer, wherein the barrier layer is attached to the silicon carbide wafer using adhesive material in the adhesion layer, and wherein the barrier layer and the adhesion layer are composed of material including titanium-tungsten (Ti—W).

14. The method of claim 10, wherein the contact layer is composed of material including one or more of nickel (Ni) and nickel-cobalt (Ni—Co).

15. The method of claim 14, wherein the barrier layer reduces or eliminates diffusion of Ni or Ni—Co into the gold-silicon eutectic solder.

16. An apparatus for providing improved backside metal contacts to silicon carbide, comprising:
a silicon carbide wafer that includes a top surface and a bottom surface;
a contact layer deposited on the bottom surface of the silicon carbide wafer, wherein the contact layer includes a top surface and a bottom surface, and wherein the top surface of the contact layer is attached to the bottom surface of the silicon carbide wafer;
a barrier layer deposited on the bottom surface of the contact layer, wherein the barrier layer includes a top surface and a bottom surface;
a silicon layer deposited on the bottom surface of the barrier layer,
wherein the silicon carbide wafer is separated into individual silicon carbide dies,
wherein a gold-silicon eutectic solder is formed by mechanically scrubbing each silicon carbide die on a top surface of a package, and wherein the gold-silicon eutectic solder bonds the silicon carbide dies to the package,
wherein the barrier layer reduces or eliminates diffusion of species into the gold-silicon eutectic solder to reduce or eliminate voids in the gold-silicon eutectic solder.

17. The apparatus of claim 16, wherein a gold layer is located on the top surface of the package, and wherein silicon in the silicon layer and gold in the gold layer reacts as a result of thermo-mechanical energy to form the gold-silicon eutectic solder.

18. The apparatus of claim 16, wherein the barrier layer is attached to the silicon carbide wafer using adhesive material in an adhesion layer, and wherein the barrier layer and the adhesion layer are composed of material including titanium-platinum (Ti—Pt).

19. The apparatus of claim 16, wherein the barrier layer is attached to the silicon carbide wafer using adhesive material in an adhesion layer, and wherein the barrier layer and the adhesion layer are composed of material including titanium-tungsten (Ti—W).

20. The apparatus of claim 16, wherein the contact layer is composed of material including one or more of nickel (Ni) and nickel-cobalt (Ni—Co), and wherein the barrier layer reduces or eliminates diffusion of Ni or Ni—Co into the gold-silicon eutectic solder.
